(19) United States
(12) Patent Application Publication
(10) Pub. No.: US 2010/0107161 A1
(43) Pub. Date: Apr. 29, 2010

(54) Method of Improving or Managing Performance of Storage System, System, Apparatus, and Program

(75) Inventor: Norifumi NISHIKAWA, Machida (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignee: Hitachi, Ltd.

(21) Appl. No.: 12/355,156

(22) Filed: Jan. 16, 2009

(30) Foreign Application Priority Data
Oct. 29, 2008 (JP) 2008-277600

(51) Int. Cl. G06F 9/455

(52) U.S. Cl. 718/1

(57) ABSTRACT

A computer system including a server computer providing plural virtual servers, a management computer, and a storage system having plural storage controllers, providing plural logical units. The server computer controls I/O processing of each virtual server according to the I/O priorities for the virtual servers to arbitrate I/O processing performance between the virtual servers. Cooperative settings between the server computer and the storage system are made or information about the storage system corresponding to a virtual server with which cooperative configurations are made is displayed.

### INCORPORATION BY REFERENCE

The present application claims priority from Japanese application JP2008-277600 filed on Oct. 29, 2008, the content of which is hereby incorporated by reference into this application.

### BACKGROUND OF THE INVENTION

The present invention relates to a method of improving or managing the performance of a storage system, system, apparatus, and program.

Virtual machine (hereinafter may be abbreviated VM) techniques are used to offer plural virtual computers using the CPUs of server computers, main storages, network interfaces, and storage interfaces. Virtual computers offered by these techniques are referred to as virtual machines or virtual servers.

In the case of server computers to which virtual machine techniques have been applied, storage interfaces (hereinafter may be referred to as I/O adapters) possessed by the computers are shared among plural virtual servers. Therefore, the I/O performance has presented problems.

U.S. Patent Application Publication No. 2008/002704 discloses a technique for controlling data bandwidth consumed by virtual servers by assigning virtual storage interfaces and data queues to each individual virtual server.

### SUMMARY OF THE INVENTION

Where the technique described in the above-cited U.S. Patent Application Publication No. 2008/002704 is applied to storage I/O, a storage system performs processing of storage I/O regardless of the settings of a virtual server. Therefore, it is difficult to manage the performance of the whole computer system.

The present invention provides a method related to management of the performance of a computer system composed of a computer (server computer) offering plural virtual servers, a management computer, and a storage system equipped with plural storage controllers offering plural logical units (LUs). The invention also provides apparatus, system program, and storage media for implementing this method.

According to one embodiment of the present invention, The server computer controls I/O processing of each virtual server according to the I/O priority for the virtual server to arbitrate I/O processing performance between the virtual servers. Cooperative settings between the server computer and the storage system are made or information about the storage system corresponding to a virtual server with which cooperative settings are made is displayed.

According to another embodiment of the invention, the server computer has I/O priority management information for managing I/O priorities for the virtual servers. Plural logical units (LUs) store plural sets of virtual disk data about the virtual servers. The storage system has LU related configuration information for identifying a storage controller for processing I/O requests for plural LUs from the plural storage controllers. The management computer has virtual server configuration information corresponding to the I/O priority management information possessed by the server computer and storage system configuration information corresponding to the LU related configuration information possessed by the storage system. The configuration of the storage system is calculated based on plural I/O priorities for plural virtual servers indicated by the I/O priority management information by referring to the virtual server configuration information and to the storage system configuration information. A storage configuration request based on the configuration is sent. After receiving the storage configuration request, the storage system modifies the LU related configuration information, thus changing the storage controller performing the I/O request for one of the LUs specified by the storage configuration request.

The management computer may have virtual disk data management information indicating the storage relationship between the plural sets of virtual disk data and the plural LUs. A storage controller corresponding to some of the virtual servers may be identified from the storage controllers by referring to the virtual disk data management information and to the storage system configuration information. Information about the identified storage controller corresponding to some of the virtual servers may be displayed. The total value of the I/O priority values for one or more virtual servers corresponding to each of the controllers may be calculated by referring to the virtual disk data management information, the storage system configuration information, and the virtual server configuration information. The result of the calculation may be displayed.

A method according to a further embodiment of the invention comprises the steps of: storing virtual server configuration information corresponding to I/O priority management information held in the server computer that manages the I/O priorities for the plural virtual servers; identifying a storage controller for processing I/O requests for the plural logical units (LUs) from the plural storage controllers; storing storage system configuration information corresponding to LU related configuration information held in the storage system; calculating the configuration of a storage system based on I/O priorities for plural virtual servers indicated by the I/O priority management information by referring to the virtual server configuration information and to the storage system configuration information; and sending a storage configuration request based on the configuration.

Furthermore, the method may include the step of storing virtual disk data management information indicating the storage relationships between the plural sets of virtual disk data and the LUs. In addition, the method may include the steps of: identifying a storage controller corresponding to some of the plural virtual servers from the plural storage controllers by referring to the virtual disk management information and to the storage system configuration system; and displaying information about the identified storage controller corresponding to some of the virtual servers. Additionally, the method may include the steps of: calculating the total value of I/O priority values for one or more virtual servers corresponding to each of the controllers by referring to the virtual disk data management information, the storage system configuration information, and the virtual server configuration information; and displaying the result of the calculation.

The present invention makes it possible to manage the performance while taking account of both the server computer offering virtual servers and the storage system.

Other objects, features and advantages of the invention will become apparent from the following description of the embodiments of the invention taken in conjunction with the accompanying drawings.

### BRIEF DESCRIPTION OF THE DRAWINGS

FIG. 1 is a diagram showing a first example of configuration of a computer system and a storage system in which the present invention is implemented.

FIG. 2 is a table showing an example of configuration of I/O priority management information that is different among different virtual disks.

FIG. 3 is a table showing an example of configuration of virtual disk data management information.

FIG. 4 is a table showing an example of configuration of management information indicating the relationships among logical units (LUs), controllers, and storage devices.

FIG. 5 is a flowchart illustrating an example of a sequence of operations performed by a control program for modifying the relationships between logical units (LUs) and controllers.

FIG. 6 is a flowchart illustrating an example of a sequence of operations performed by a control program for modifying the relationships between logical units (LUs) and controllers.

FIG. 7 is a table showing an example of configuration obtained after updating the I/O priority management information that is different among different virtual disks.

FIG. 8 is a table showing an example of configuration obtained after making a first modification to the management information indicating the relationships among logical units (LUs), controllers, and storage devices.

FIG. 9 is a table showing an example of configuration of capacity management information.

FIG. 10 is a table showing an example of configuration of information for managing the relationship between logical units (LUs) and I/O priority.

FIG. 11 is a table showing an example of configuration obtained after making a second modification to the management information indicating the relationships among logical units (LUs), controllers, and storage devices.

### DESCRIPTION OF THE EMBODIMENTS

Embodiments of the present invention are hereinafter described.

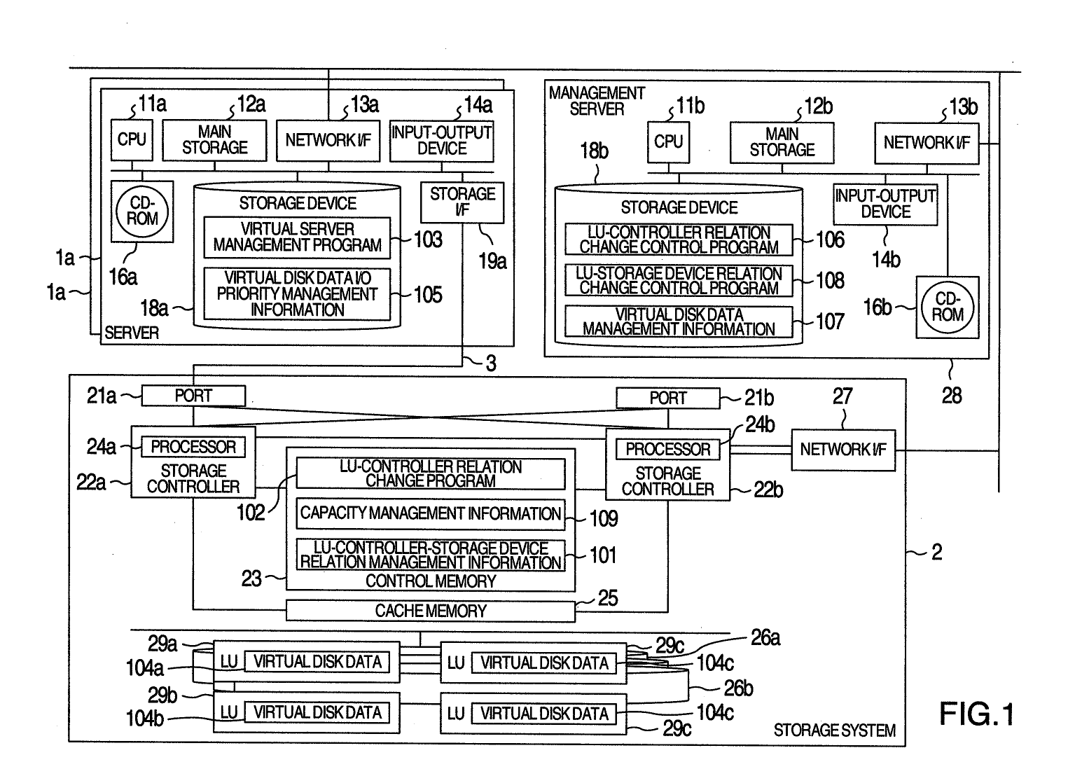

FIG. 1 shows an example of configuration of a computer system in which the present invention is implemented. The computer system is composed of at least one server computer (hereinafter simply referred to as the server) 1a, a storage system 2, and a management server computer (hereinafter may be simply referred to as the management server) 28. The server 1a and storage system 2 are interconnected by a first network 3 that connects together a data interface or storage interface 19a of the server 1a and a port 21a of the storage system. The server 1a, storage system 2, and management server 28 have network interfaces 13a, 27, and 13b, respectively, which are connected with a second network 4. Consequently, communications can be accomplished among the server 1a, management server 28, and storage system 2.

The server 1a is composed of a CPU 11a, a main storage 12a, the network interface 13a, an input-output (I/O) device 14a, a storage device 18a, and the storage interface (I/F) 19a. The server 1a may have a CD-ROM drive 16a. Besides, the server may have other components. Conceivable examples of the input-output device 14a are a display device, a keyboard, and a pointing device. Other devices may also be included. Alternatively, inputting and display with the input-output device 14 may be done by using a serial interface or Ethernet interface as an input-output device, connecting a display computer having a display device, a keyboard, or a pointing device with the interface, and sending information for display to the display computer or receiving information for inputting from the display computer to thereby provide a display on the display computer or accept inputs.

The storage system 2 is composed of the port 21a, another port 21b, storage controllers 22a, 22b, a control memory 23, a processor 24a, a cache memory 25, storage devices 26a, 26b, and the network interface 27.

The storage controller 22 offers plural logical units (LUs) 29 (29a-29d) to the server 1a or to virtual servers offered by the server 1a using storage regions of the plural storage devices 26. The LUs 29 are storage regions that can be accessed from the server 1a. An identifier known as a LUN (logical unit identifier) is assigned to each LU 29 by Fibre Channel or iSCSI. The server 1a specifies one LU 29 using the LUN to send an I/O request typified by a read request or write request to the storage system 2.

Some of the LUs 29 store virtual disk data 104 corresponding to virtual servers. The virtual disk data 104 store information about the virtual hardware configuration (e.g., the number of CPUs, the number of network interfaces, or storage capacity) offered by virtual servers or store files of an OS activated by the virtual servers or files used by the user of the virtual servers. Other information such as the contents of a memory space offered by the virtual servers may be stored in the virtual disks. Each virtual disk may be made of one or more files.

The management server 28 is composed of a CPU 11b, a main storage 12b, the network interface 13b, an input-output device 14b, and a storage device 18b. The management server 28 may has a CD-ROM drive 16b. In addition, the server may include other components. Conceivable examples of the input-output device 14b are a display device, a keyboard, and a pointing device. Other devices may also be included. Alternatively, inputting and display with the input-output device 14 may be done by using a serial interface or Ethernet interface as an input-output device, connecting a display computer having a display device, a keyboard, or a pointing device with the interface, and sending information for display to the display computer or receiving information for inputting from the display computer to thereby provide a display on the display computer or accept inputs.

A virtual server management program 103 and virtual disk data I/O priority management information 105 are stored in the storage device 18 of the server 1a. The virtual server management program 103 is read into the main storage 12a by the CPU 11a and executed. The virtual server management program 103 may be stored into the storage device 18 via the CD-ROM drive 16.

A program 102 for changing the relationship between the LUs and controllers, capacity management information 109, and information 101 about the relationships among the LUs, controllers, and storage devices are stored in the control memory 23 of the storage system 2.

An LU-controller relation change control program 106, an LU-storage device relation change control program 108, and virtual disk data management information 107 are stored in the storage device 18b of the management server 28. The LU-controller relation change control program 106 and the LU-storage device relation change control program 108 are read into the main storage 12b of the management server 28 by the CPU 11b of the management server 28 and executed. The LU-controller relation change control program 106 and the LU-storage device relation change control program 108 are stored into the storage device 18b of the management server 28 via the CD-ROM drive 16.

The LUs 29 that are managed by the virtual server management program 103 are disposed in the storage devices 26. Virtual disk data 104 read into the main storage 12 by the CPU 11a of the server 1a and executed is stored in the LUs 29, which are used by the virtual servers.

The CD-ROM drive 16 shown in FIG. 1 is a means for reading a program from a storage medium. The CD-ROM drive may be replaced by a Floppy (trademark registered) disk drive, a tape reader, or other storage medium drive. The virtual server management program 103 may be stored into the storage device 18b via the network interface 13b.

Furthermore, the virtual server management program 103 and virtual disk data I/O priority management information 105 may be disposed in the LUs 29 on the storage devices 26 of the storage system 2.

The server 1a can be singular or plural. In addition, a computer that does not offer virtual servers may be coupled to the storage system 2 to read or write data to or from the LUs 29. The LUs 29 accessed at this time may or may not contain the virtual disk data 104.

A summary of the present invention is next described. It is to be noted that items not mentioned in the summary are not disclaimed.

The present invention facilitates management of the performance of each virtual server offered by the server 1a as a computer system by causing the server 1a and the storage system 2 to cooperate with each other by controlling the I/O processing of the virtual servers in accordance with the I/O priorities. The virtual server management program 103 for arbitrating the I/O processing performance between the virtual servers is held in the server 1a. The management server 28 is a computer for causing the server 1a and storage system 2 to cooperate with each other.

That is, information about the I/O priorities for the virtual servers offered by the server 1a is acquired. Based on the acquired information, a request for setting (storage configuration request) associated with the performance of the storage system 2 is created and sent to the storage system 2. Receiving the configuration request, the storage system modifies given configuration information (hereinafter referred to as the LU related configuration information) about the performance of the LUs of the storage controllers 22 (22a, 22b) for the I/O request in accordance with the configuration request. Subsequently, the storage system 2 processes the I/O request received from virtual servers based on the modified LU related configuration information, one example of which is management information about the relationships among the LUs, controllers, and storage devices. The management of the performance of the computer system is facilitated by modifying the processing configurations used to modify the LU-related configurations of the storage system 2 in accordance with the I/O priorities for the virtual servers in this way.

Especially, the cooperative processing performed by the server 1a offering the virtual servers and the storage system 2 makes it easier to manage the performance under circumstances including the cases described below.

(Case 1): It is assumed that a virtual server (referred to as virtual server VS-A) has an I/O priority value of Pa and that another virtual server (referred to as virtual server VS-B) is made to correspond to an I/O priority value of Pb lower than the I/O priority value Pa. In this case, a write request is received from the virtual server VS-B. The request is executed with storage resources accompanying the I/O priorities owing to the processing performed by the management server. For example, the storage resources indicate the ratios at which the I/O request is processed by the storage controllers 22, cache memory 25, and processors 24a, 24b. Therefore, it is unnecessary to assign an excessive amount of storage resource. The I/O request from the virtual server VS-A can be processed with more resources.

(Case 2): A read request is received from the virtual server VS-A made to correspond to the I/O priority value Pa higher than the I/O priority value Pb for the virtual server VS-B. It is possible to circumvent the situation where insufficient storage resources are used for the processing for sending read data complying with the read request such that the virtual server VS-B has better I/O request handling performance, i.e., I/O performance has a reverse relationship to I/O priority.

(Case 3): A non-virtualized server computer offering no virtual servers is connected with the storage system 2, which in turn processes the I/O request from the computer. Deterioration of the I/O performance of the virtual servers can be avoided by causing different storage controller or storage device to perform the processing of the I/O request corresponding to the non-virtualized server computer in accordance with the I/O priorities for the virtual servers.

(Case 4): Reading processing complying with the read request from the server computer or processing different from writing processing complying with the writing processing is performed in the storage system 2. In this case, the storage system 2 has management information indicating what storage controller executes the different processing. The information is modified according to the I/O priorities for the virtual servers. Where the management information is not directly associated with LUs but the processing is controlled according to the I/O priorities, the information can be regarded as LU related configuration information in a broad sense. Deterioration of the I/O performance of the virtual servers can be avoided by causing a different storage controller or storage device to perform the different processing in this way. Conceivable examples of the different processing include parity calculation using the RAID technology, recovery processing performed when a fault occurs in any of the storage devices 26 when the RAID technology is applied, processing for copying data stored in the storage devices 26 by the storage system 2 (remote copy or local copy), processing for formatting the storage devices 26, processing for deleting data, and processing of the storage controller executed non-synchronously with read processing or write processing.

The management server 28 displays the I/O priorities for the virtual servers and LU related configuration information in response to the configuration request for the user of the management server 28. For this display, it is considered that the management server 28 identifies the LU (in which virtual disk data 104 about the virtual server is stored) corresponding to the virtual server to be displayed by referring to the virtual disk data I/O priority management information 105 and the virtual disk data management information. The configurations of the processing of the storage system to which the identified LU is associated are displayed. As a result, the user of the virtual server 28 can easily confirm the configurations of the virtual server and storage system.

In the following embodiment, follow-up processing performed when LU-related information is given is described.

### (Follow-Up Processing 1)

The storage controller performing I/O processing of the selected LU is modified to a different storage controller. Subsequently, I/O processing of the selected LU is performed by the different storage controller. Consequently, deterioration of the performance of the processing of the I/O request to the LU corresponding to the virtual disk data having an increased I/O priority due to the storage controller (especially, where the IOPS is high) can be circumvented.

### (Follow-Up Processing 2)

The data in the selected LU is moved from the presently stored storage device to another storage device. Consequently, deterioration of the performance of the processing of the I/O request to the LU corresponding to the virtual disk data having an increased I/O priority due to the storage device (especially, where the throughput is high or where the IOPS is high under environments where the cache effect is not strong) can be circumvented.

As long as the I/O request to the LU corresponding to the virtual disk data having increased I/O priority can be arbitrated, the performed processing is not limited to the above-described follow-up processing.

In the embodiment of the invention, to simplify the description, it is assumed that logical units (LUs) are defined on plural storage devices. Where RAID technology is introduced, it is considered that plural storage devices are organized into a parity group and that logical units (LUs) are defined for the parity group. In this case, the storage devices may be read as a parity group, and various kinds of processing or information may be managed.

In addition, in the embodiment of the invention, I/O priority corresponds to virtual disk data. The invention can also be applied to the case where I/O priority is assigned to a virtual server. In this case, I/O priority for virtual disk data may be read as I/O priority for a virtual server.

A summary of the present invention has been given so far.

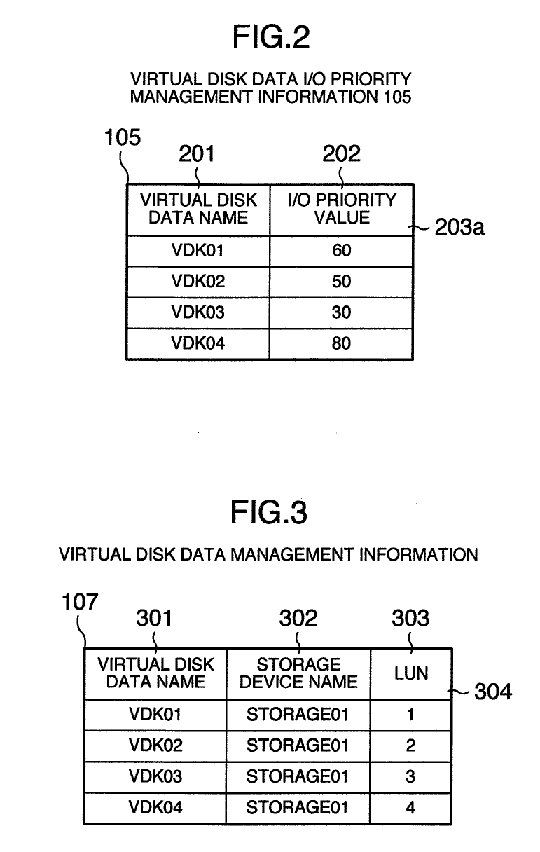

FIG. 2 shows an example of virtual disk data I/O priority management information 105. The management information 105 is in the form of a table composed of virtual disk data name fields 201 for storing the names or identifiers of virtual disk data and I/O priority fields 202 for storing the I/O priority values that are I/O priority values for the virtual disk data. If the virtual disk data I/O priority management information 105 can store the I/O priority for the virtual disk data, a data structure other than a table can be adopted.

Based on the information, the virtual server management program 103 performs processing for sending, receiving, or otherwise processing a read request or write request issued by the OS of the virtual server in accordance with the priority.

FIG. 3 shows an example of configuration of the virtual disk data management information 107. The management information 107 is in the form of a table composed of virtual disk data name fields 301 for storing the names or identifiers of virtual disk data, storage device name fields 302 for storing the names or identifiers of the storage system that stores the virtual disk data, and LUN fields 303 for storing a number or identifier given to the LU in which the virtual disk data is stored. If the storage system 2 in which the virtual disk data is stored and the LU 29 can be identified, the virtual disk data management information 107 can have a data structure other than a table.

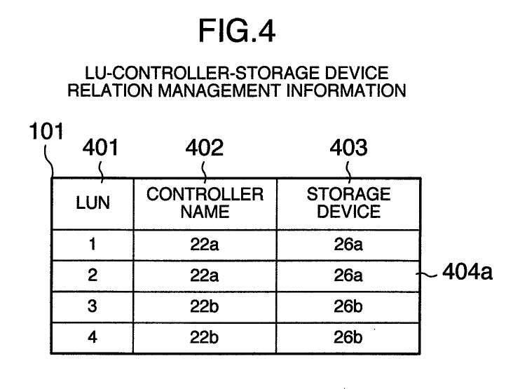

FIG. 4 shows an example of configuration of LU-controller-storage device relation management information 101. The information is in the form of a table composed of LUN fields 401 for storing a number or an identifier given to each LU, controller name fields 402 indicating controllers providing I/O control of the LUs, and storage device fields 403 indicating storage devices in which the LUs are stored. If a controller performing I/O processing can be identified for each LU, the management information 101 about the relations among LUs, controllers, and storage devices can have a data structure other than a table.

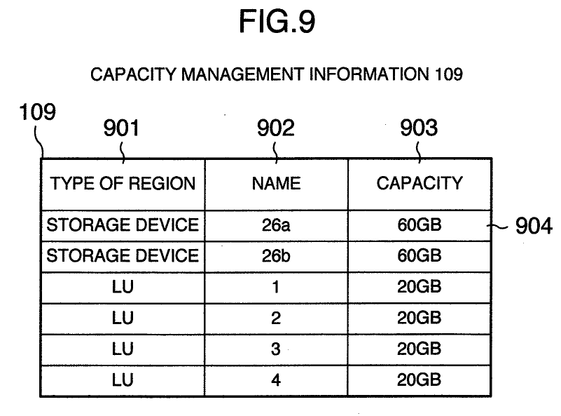

FIG. 9 shows an example of configuration of the capacity management information 109 for managing the capacities of storage devices and logical units (LUs). The management information is in the form of a table including region type fields 901 indicating the type of each storage region, name fields 902 indicating the names of the storage regions, and capacity fields 903 indicating the capacities of the regions. If these kinds of information are stored in the fields, the information can assume a data structure other than a table.

In the management server, storage system configuration information is stored in its main storage 12b or storage device 18b. A storage system information acquisition program held in the management server and executed by the CPU 11b sends an LU related configuration information acquisition request to the storage system 2. The storage system 2 receiving the request sends the LU-controller relational information and LU-storage device relational information stored in the LU-controller-storage device relation management information 101. The storage system information acquisition program receiving the relational information stores the relational information between the LUs and the controllers and the relational information between the LUs and the storage devices into the storage system configuration information, based on the relational information. Thus, the storage system configuration information is managed.

In the management server, virtual server configuration information is stored in its main storage 12b or storage device 18b. The virtual server information acquisition program held in the management server and executed by the CPU 11b sends an I/O priority acquisition request to one or more servers 1a. The servers 1a receiving the request send I/O priority information including the I/O priority for the virtual disk (or I/O priority for a virtual server) data stored in the virtual disk data I/O priority management information 105. The virtual server information acquisition program receiving the information stores I/O priority for the virtual server into the virtual server configuration information based on the received information. Thus, the virtual server configuration information is managed.

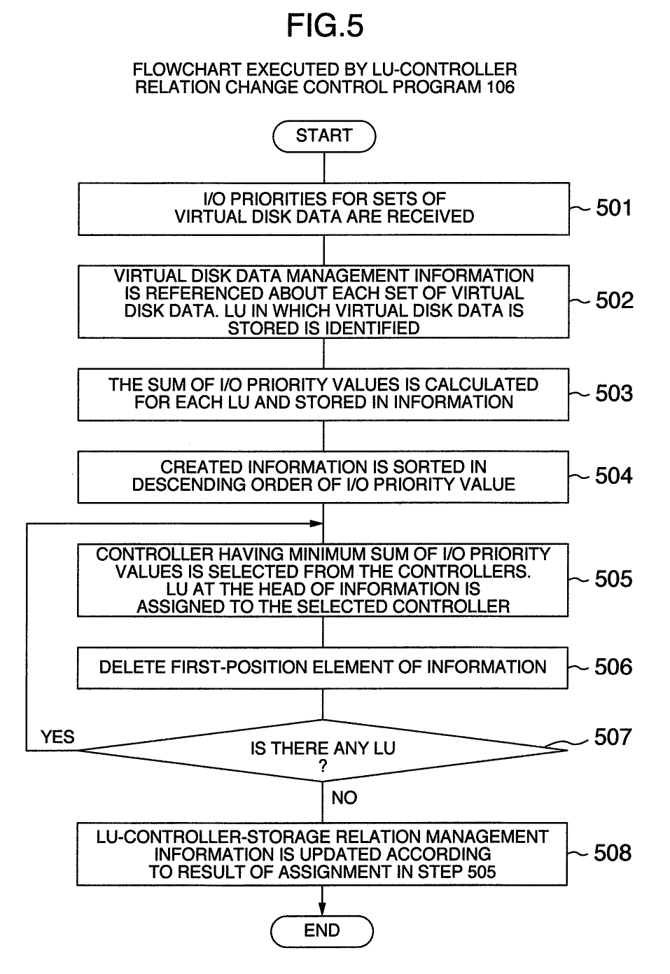

FIG. 5 shows an example of processing executed by the LU-controller relation change control program 106. Processing performed when the CPU 11b executes the program is described below. The following processing is carried out by referring to the virtual server configuration information, virtual disk data management information 107, and virtual disk data management information unless otherwise specifically stated.

(Step 501) The program receives I/O priority for each virtual disk. The following two methods are available to acquire I/O priorities.

(Method 1) In this method, I/O priorities are acquired by the virtual server management program 103. An I/O priority acquisition request is sent to the server 1a. The server 1a receiving the request sends an identifier for a virtual server and I/O priority information including I/O priorities, thus updating the latest virtual server configuration information. The server refers to the information.

(Method 2) In this method, I/O priorities are received from an administrator. The program receives an I/O priority for the virtual server entered through the input-output device 14b. Where an I/O priority for each virtual disk is acquired from the administrator, a message indicating whether or not the information should be transmitted to the virtual server management program 103 is received at the same time. Where the message indicates that the information should be transmitted, I/O priority configuration information including the I/O priority and the identifier for the virtual server corresponding to the I/O priority is sent to the server 1a. The server 1a receiving the I/O priority configuration information updates the virtual disk data I/O priority management information 105 based on the configuration information. Furthermore, the program updates the virtual server configuration information.

The method used by the virtual server management program is not limited to method 1 or method 2 above. The virtual server management program receives an I/O priority configuration request including I/O priority configuration information containing an I/O priority corresponding to the identifier for the virtual server from the network interface 13a or from the input-output device 14a. The server 1b receiving the I/O priority configuration request updates the virtual disk data I/O priority management information 105 based on the configuration information.

(Step 502) Logical units (LUs) where sets of virtual disk data are stored are identified by referring to the virtual disk data management information 107 about each set of virtual disk data.

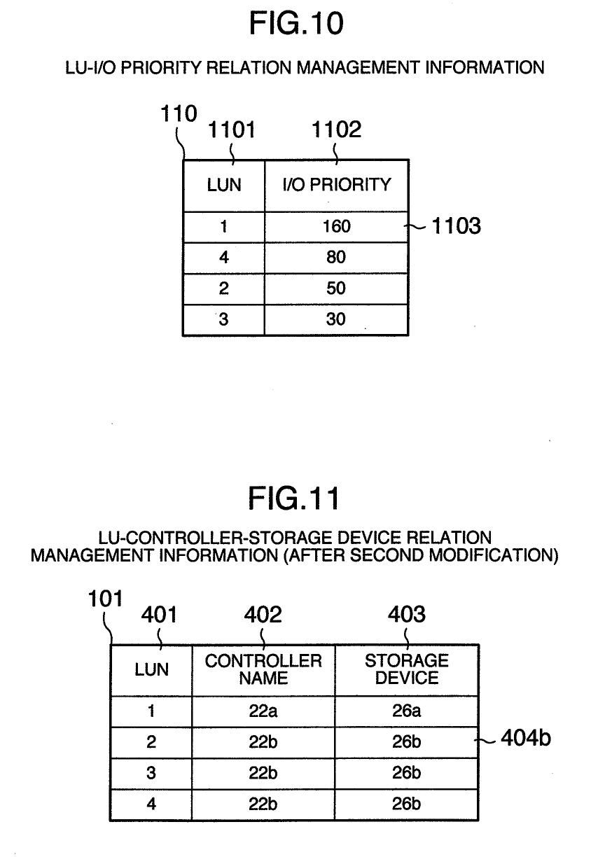

(Steps 503 and 504) I/O priority values for virtual disk data that are identification sources are summed up for each LU found in step 502. The sum of the I/O priority values for each LU is calculated. The result of the calculation is stored in the LU-I/O priority relation management information 110 (FIG. 10) that is stored in the main storage 12b or in the storage device 18b. The information is sorted in the descending order of I/O priority values. The LU-I/O priority relation management information 110 shown in FIG. 10 stores the sum of I/O priority values for each LU into an entry item 1102 indicated by another entry item 1101.

(Steps 505, 506, and 507) A storage controller that is smaller than any other storage controller in terms of sum of I/O priority values for storage controllers is selected. The logical unit (LU) at the head of the information is judged to be assigned to the storage controller. The first row of the information is deleted. This series of operations is repeated until all the records are removed from the information. The result of decision is stored as decision result information into the main storage 12b or into the storage device 18b.

(Step 508) The relationship between the LUs and controllers in the LU-controller-storage device relation management information 101 is updated according to the decision result information in step 505. Where the I/O priority values for individual virtual disks are received from the administrator and, at the same time, a message indicating that the information should be transmitted to the virtual server management program is received, the virtual disk-specific I/O priority management information 105 may be modified to the value received in step 501 for the virtual server management program 103.

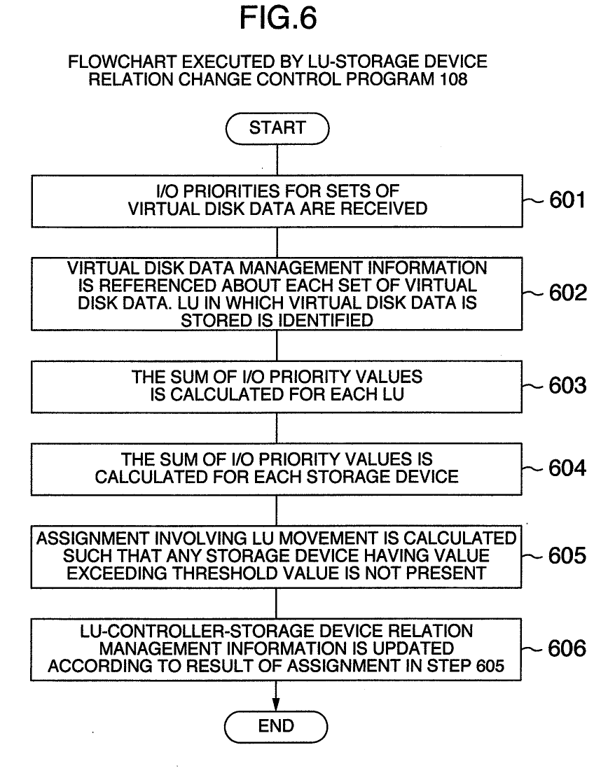

FIG. 6 shows an example of processing executed by the LU-storage device relation change control program 108. The processing carried out when the CPU 11b executes the program is described below. The following processing is performed by referring to the virtual server configuration information, virtual disk data management information 107, and virtual disk data management information unless otherwise specifically stated.

(Step 601) The program receives I/O priority values for individual sets of virtual disk data. A conceivable method of receiving the I/O priority values is the same as the method described in step 501.

(Step 602) The program identifies the LU where the virtual disk data is stored by referring to the virtual disk data management information about each set of virtual disk data.

(Step 603) The program adds up the I/O priority values for the sets of virtual disk data that are identification sources about each LU identified in step 602, and calculates the sum of the I/O priority values for each LU.

(Step 604) The program identifies the storage device where the LU is stored by referring to the LU-controller-storage device relation management information 101 based on the result of calculation in step 603, and calculates the sum of the I/O priority values for LUs becoming an identification source about each storage device. In this way, the I/O priority value for each storage device is computed.

(Step 605) The program makes a decision as to whether any one of the I/O priority values for the storage devices is in excess of a threshold value. If the threshold value is exceeded, the calculation in step 604 is performed in a case where the relation between the LUs and storage devices is varied. Consequently, the relation between the LU where the I/O priority values for the storage devices do not exceed the threshold value and each storage device is calculated. In some cases, a relation in which the threshold value is not exceeded may be calculated. In other cases, the relation may not be calculated. The capacities of the LUs and the amount of space in each storage device are required for the calculation. These are found by referring to the LU-controller-storage device relation management information 101 and the capacity management information 109 shown in FIG. 4. The result of calculation is stored as calculation result information into the main storage 12b or into the storage device 18b.

(Step 606) Then, if the decision at step 605 is that a new relation between a new LU and each storage device has been calculated based on the present configuration and on the calculation result information, data about the LU about which the relation with the storage device has been modified is moved from the source storage device to the destination storage device according to the calculation result information. The relation between LU and storage device in the LU-controller-storage device relation management information 101 is updated. Where the I/O priority values for individual virtual disks are received from the administrator and simultaneously a message indicating that the information should be transmitted to the virtual server management program is received, the virtual disk-specific I/O priority management information 105 may be modified to the value received in step 601 for the virtual server management program 103.

The operation of the configuration of FIG. 1 when the assignment of storage controllers is varied as already described in connection with FIG. 5 under the following conditions is described below.

(1) The logical units (LUs) 29a and 29b are made to correspond to the storage device 26a. The LUs 29c and 29d are made to correspond to the storage device 26b.

(2) The server 1a offers virtual servers 1 to 4 by processing the virtual server management program 103.

(3) The virtual server 1 is offered using virtual disk data 104a. VDK01 is assigned as the name of the virtual disk data. The virtual server 1 offers an I/O priority value of 60 to the virtual disk data 104a. I/O processing of the LU 29a in which the virtual disk data 104a is stored is performed by the storage controller 22a.

(4) The virtual server 2 is offered using virtual disk data 104b. VDK02 is assigned as the name of the virtual disk data. The virtual server 2 offers an I/O priority value of 50 to the virtual disk data 104b. I/O processing of the LU 29b in which the virtual disk data 104b is stored is performed by the storage controller 22a.

(5) The virtual server 3 is offered using virtual disk data 104c. VDK03 is assigned as the name of the virtual disk data. The virtual server 3 offers an I/O priority value of 30 to the virtual disk data 104c. I/O processing of the LU 29c in which the virtual disk data 104c is stored is performed by the storage controller 22b.

(6) The virtual server 4 is offered using virtual disk data 104d. VDK04 is assigned as the name of the virtual disk data. The virtual server 4 offers an I/O priority value of 60 to the virtual disk data 104d. I/O processing of the LU 29d in which the virtual disk data 104d is stored is performed by the storage controller 22b.

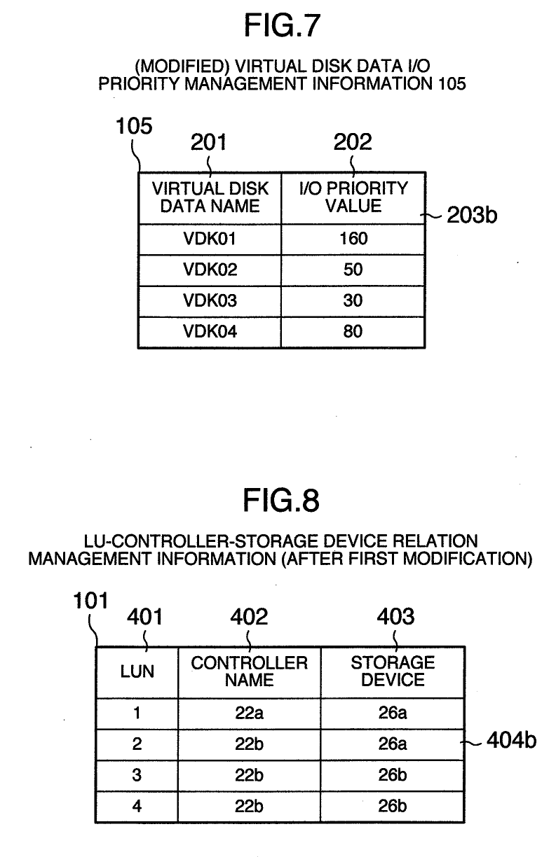

Under the condition described so far, in a case where the I/O priority value for the virtual disk data 104a is modified to 160 based on the I/O priority configuration information received by the server 1a, the computer system operates as follows. FIG. 7 shows modified virtual disk data I/O priority management information 105.

### (Operation 1)

The LU-controller relation change control program 106 calculates the I/O priority value for the LU 29a to be 160 by performing the processing of steps 501, 502, and 503. The obtained information is stored. Where plural sets of virtual disk data are stored in one logical unit (LU), the virtual disk data is not directly an I/O priority value.

### (Operation 2)

The LU-controller relation change control program 106 calculates the I/O priority value for the storage controller 22a to be 210 by performing the processing of steps 504, 505, and 506. The I/O priority value for the storage controller 22b remains at 110. Of LUs corresponding to the storage controller 22a, the LU 29b having the lowest I/O priority value is identified.

### (Operation 3)

As a result of operation in step 508, the management server 28 sends an LU-controller relation change request to the storage system 2. The storage system 2 receiving the request varies the LU-controller-storage device relation management information 101. The storage system 2 refers to the management information 101. Thus, I/O processing of the LU 29b is subsequently performed by the controller 22b. FIG. 8 shows the modified LU-controller-storage device relation management information 101. The LU-controller relation change request specifies an LU and a controller. At this time, the LU 29b and storage controller 22b are specified.

As described so far, it has been confirmed that the present invention makes it possible to vary the assignment of controllers based on the I/O priorities for the virtual disks.

Operations performed when the assignment of logical storages is modified are described below. The following illustrative situation is the same as the aforementioned modification of assignment of controllers. The modification of assignment of storage devices involves data movement and so it takes a long time until the processing is completed. Therefore, the present processing may be done only when the differences in total value of I/O priority values for individual storage devices reach a given value or a given ratio (e.g., a factor of 1.5).

### (Operation 1)

The LU-controller relation change control program 106 calculates the I/O priority value for the LU 29a to be 160 by performing the processing of steps 601, 602, and 603 and stores the obtained information.

### (Operation 2)

The LU-controller relation change control program 106 calculates the I/O priority value for the storage device 26a to be 210 by performing the processing of steps 604 and 605. The I/O priority value for the storage device 26b remains at 110. Of LUs corresponding to the storage device 26a, the LU 29b having the lowest I/O priority value is identified.

### (Operation 3)

Because of the operation of step 606, the management server 28 sends an LU-storage device relation change request to the storage system 2. An LU-controller relation change request specifies an LU and a storage controller. At this time, the LU 29b and storage controller 22b are specified. The storage system 2 receiving the request moves the data in the specified LU 29b from the storage device 26a to the storage device 26b, modifying the LU-controller-storage device relation management information 101. FIG. 11 shows the modified LU-controller-storage device relation management information 101.

As described thus far, it has been confirmed that the present invention makes it possible to vary the assignment of storage devices based on the I/O priorities for the virtual disks.

The manner in which management information is displayed by the management server 28 in the present invention is next described. In the example of the present invention as described so far, the management server modifies the configurations of storage devices according to modification of the I/O priorities for virtual disk data in the virtual servers or I/O priorities for the virtual servers. However, in some cases, the I/O processing load has no movement destination because of limitations of the performance of controllers and storage devices. In other cases, because of problems with the reliability and cost, I/O processing load on some LUs cannot be moved. In addition, in further cases, it is desired to check whether or not a modification made by the management server is appropriate.

In the present invention, the management server may display the following information to cope with these situations.

### (Mode of Display 1)

The present virtual disk data (or virtual server) and an identifier for a storage controller for processing of an I/O request about an LU in which the present virtual disk data is stored. To display the information, the management server refers to virtual disk data management information 107 and storage system configuration information.

### (Mode of Display 2)

The sum of the I/O priority value for the present virtual disk data (or the I/O priority value for the virtual server) and the I/O priority value for the storage controller for performing I/O processing about the LU in which the virtual disk data is stored, the latter I/O priority value being found in step 503. Alternatively, other configuration information associated with the processing performance of the storage controllers or configuration information. To display the information, the management server refers to virtual server configuration information in addition to the information referenced in the mode of display 1.

### (Mode of Display 3)

The present virtual disk data (or virtual server) and an identifier for a storage device corresponding to an LU in which the present virtual disk data is stored. The management server refers to the same information as in the mode of display 1 to display the information.

### (Mode of Display 4)

The sum of the I/O priority value for the present virtual disk data (or I/O priority value for the virtual server) and the I/O priority value for the storage controller performing I/O processing about the LU in which the virtual disk data is stored, the latter I/O priority value being found in step 503. To display the information, the management server refers to the virtual server configuration information in addition to the information referenced in the mode of display 3.

The program and information about the management server 28 as described so far are present in the server 1a. The program may be executed. Similarly, the program and information may be stored in a control memory or management memory for the storage system 2, and the storage controller 22 of the storage system may execute the program. In this case, display and inputting are achieved by a method similar to the method used where the management server has an Ethernet port or a serial interface.

In the description provided so far, it is assumed that the storage system 2 consists of one apparatus. Similar concept can be applied to a clustered storage system having plural storage systems 2 connected together. That is, if storage systems A and B are contained in a clustered storage system, then storage controller A, storage device A, and port A possessed by the storage system A are considered as the storage controller 22a, storage device 26a, and port 21a, respectively. Storage controller B, storage device B, and port B of the storage system B are considered as the storage controller 22b, storage device 26b, and port 21b, respectively. Under these conditions, data in a logical unit (LU) is moved from the storage system A to the storage system B according to modification of the I/O priority for virtual disk data. Concomitantly, the port and storage controller corresponding to the LU are set to port B and storage controller B, respectively. As a result, similar merits are obtained.

Where the port is switched, a switching request is sent to the server 1a. This switches the transmission destination of the I/O request sent by the server 1a from port A to port B, thus achieving the switching of the port. The switching may also be performed without modifying the OS settings corresponding to the virtual server by causing the virtual server management program to perform the processing.

It should be further understood by those skilled in the art that although the foregoing description has been made on embodiments of the invention, the invention is not limited thereto and various changes and modifications may be made without departing from the spirit of the invention and the scope of the appended claims.

1. A computer system comprising:
a server computer providing plural virtual servers;
a management computer; and
a storage system having plural storage controllers, providing plural logical units,
wherein the server computer has I/O priority management information to manage I/O priorities of the plural virtual servers,
wherein the plural logical units store plural sets of virtual disk data about the virtual servers;
wherein the storage system has logical unit related configuration information to identify a storage controller that processes I/O requests to each of the plural logical units, from the plural storage controllers,
wherein the management computer has virtual server configuration information corresponding to the I/O priority management information held in the server computer and storage system configuration information corresponding to the logical unit related configuration information held in the storage system,
wherein the management computer calculates configuration of the storage system based on I/O priorities of the plural virtual servers indicated by the I/O priority management information by referring to the virtual server configuration information and to the storage system configuration information and sends a storage configuration request based on the configuration of the storage system, and
wherein the storage system changes a storage controller that processes an I/O request designated to one of the plural logical units specified by the storage configuration request, by modifying the logical unit related configuration information according to the storage configuration request.

2. A computer system according to claim 1, wherein the management computer has virtual disk data management information indicating storage relationships between the plural sets of virtual disk data and the plural logical units.

3. A computer system according to claim 2, wherein the management computer identifies a storage controller corresponding to a part of the plural virtual servers from the plural storage controllers by referring to the virtual disk data management information and the storage system configuration information and displays information regarding the identified storage controller corresponding to the part of the plural virtual servers.

4. A computer system according to claim 2,
wherein, for each of the plural storage controllers, the management computer calculates a total I/O priority values of one or more virtual servers corresponding to, by referring to the virtual disk data management information, the storage system configuration information, and the virtual server configuration information and displays results of the calculation.

5. A method of managing performance by a management computer coupled to a server computer providing plural virtual servers, and to a storage system having plural storage controllers providing plural logical units in which plural sets of virtual disk data about the plural virtual servers are stored, the method comprising:
storing virtual server configuration information corresponding to I/O priority management information held in the server computer that manages I/O priorities of the plural virtual servers;
storing storage system configuration information, corresponding to logical unit related configuration information held in the storage system identifying a storage controller processing I/O requests to the plural logical units from the plural storage controllers; and
calculating configuration of the storage system based on I/O priorities of the plural virtual servers indicated by the I/O priority management information, by referring to the virtual server configuration information and to the storage system configuration information; and
sending a storage configuration request based on the configuration of the storage system.

6. A method of managing performance by a management computer according to claim 5, comprising:
storing virtual disk data management information indicating storage relationships between the plural sets of virtual disk data and the plural logical units.

7. A method of managing performance by a management computer according to claim 6,comprising:
identifying a storage controller corresponding to a part of the plural virtual servers from the plural storage controllers, by referring to the virtual disk data management information and the storage system configuration information; and
displaying information regarding the identified storage controller corresponding to the part of the virtual servers.

8. A method of managing performance by a management computer according to claim 6, comprising:
calculating a total value of I/O priority values about one or more virtual servers corresponding to the plural storage controllers, by referring to the virtual disk data management information, the storage system configuration information, and virtual server configuration information,
displaying results of the calculation.
